(19) United States
(12) Patent Application Publication
(10) Pub. No.: US 2016/0029561 A1
(43) Pub. Date: Feb. 4, 2016

(54) FORAGE HARVESTER AND OPERATING METHOD THEREFOR

(71) Applicant: CLAAS SELBSTFAHRENDE ERNTEMASCHINEN GMBH, HARSEWINKEL (DE)

(72) Inventors: FREDERIC FISCHER, ARNSBERG (DE); BASTIAN KRIEBEL, MUENSTER (DE); INGO BOENIG, GUETERSLOH (DE); ALLAN KILDEBY, ESPERGAERDE (DK); HAGALIN ASGRIMUR GUOMUNDSSON, BAGSVAERD (DK)

(21) Appl. No.: 14/816,291

(22) Filed: Aug. 3, 2015

(30) Foreign Application Priority Data
Aug. 4, 2014 (DE) 102014011308.6

(51) Int. Cl. A01F 11/06; B02C 11/00; G06K 9/62; G06T 7/00; G06T 7/60

(52) U.S. Cl. CPC A01F 11/06; G06T 7/001; G06T 7/602; G06K 9/6268; B02C 11/00; G06T 2207/30128

(57) ABSTRACT

A method for operating a forage harvester includes steps of capturing images of chopped material produced in the forage harvester using a camera, identifying images of kernel-type particles in the images, sorting the images of the kernel-type particles into at least two size fractions and determining a cardinality of the size fractions.

### CROSS-REFERENCE TO A RELATED APPLICATION

The invention described and claimed hereinbelow is also described in German Patent Application DE 10 2014 011308.6, filed on Aug. 4, 2014. This German Patent Application, subject matter of which is incorporated herein by reference, provides the basis for a claim of priority of invention under 35 U.S.C. 119(a)-(d).

### BACKGROUND OF THE INVENTION

The invention broadly relates to a forage harvester comprising an after-treatment device and an operating method therefor.

EP 2 452 550 A1 makes known a forage harvester and an operating method therefor, in which a camera produces images of chopped crop and an image evaluation device evaluates the portion of husks, stalk pieces, and whole corn kernels in the chopped material. On the basis of the determined portions, the method attempts to optimize the operation of the chopping mechanism. To this end, the length of cut of the crop is regulated, in particular on the basis of the stalk portion and the need for sharpening is decided on the basis of the husk portion. An after-treatment device is controlled such that a pre-definable portion of corn kernels in the crop is not exceeded. Ideally, there should not be any whole corn kernels in the chopped material, since, if the chopped material is used as animal feed, the animals have a difficult time consuming and digesting these whole corn kernels. Intact kernels also are unwanted when the chopped material is used for biogas production. Since intact kernels and even coarse kernel fragments ferment slowly and incompletely, their energy content goes largely unused. Therefore, in the case of chopped material for biogas production, the kernels should be chopped even more finely than is the case for use as animal feed.

Although the portion of intact kernels easily can be kept low by a narrow setting of a cracker gap of the after-treatment device or a high speed differential between rollers delimiting the cracker gap, it is obvious that the more drive energy that must be used, the more finely the kernels are chopped. Therefore, an optimal extent of chopping exists that should not be fallen below, because the energy used for chopping does not result in a corresponding improvement of the energy yield for biogas production.

With the conventional method, it is difficult to evaluate whether the extent of chopping required for a given use of the chopped material has been reached, since, if this is the case, the intact kernels have only a very small portion of the total mass of the chopped material and the extent of chopping of the kernels can vary greatly without this having a noticeable effect on the portion of whole kernels. It is even more difficult to differentiate the optimal extent of chopping from unnecessarily fine chopping. However, this is precisely what is required for fuel efficient operation of the forage harvester.

### SUMMARY OF THE INVENTION

The present invention overcomes the shortcomings of known arts, such as those mentioned above.

To that end, the invention provides a forage harvester and a method for operating a forage harvester, by which chopped material is produced in an energy-efficient manner and kernel sizes are produced that are adapted to the particular intended use.

In a method embodiment, the invention operates a forage harvester having the steps of:

a) capturing images of chopped material produced in the forage harvester, by means of a camera;

b) identifying images of kernel-type particles in the images;

c) sorting the images of the kernel-type particles into at least two size fractions; and

d) determining the cardinality of the size fractions.

The cardinality values are used to obtain at least two data values, on the basis of which the extent of chopping of the kernels is deduced. Therefore, it is no longer necessary to compare a kernel portion with non-kernel portions of the chopped material, thereby making it possible to evaluate the chopping quality in a manner that is more accurate and is more independent of interferences.

In an embodiment, the cardinality of each fraction is evaluated on the basis of the number of particles that have been assigned to the relevant fraction in the sorting step c). Such a method requires very little processing effort beyond identifying and sorting the kernel-type particles. Since a plurality of fragments is produced from each kernel in the chopping mechanism, this type of evaluation is relatively insensitive to small fluctuations of the portion of kernels that have not been chopped or that have been insufficiently chopped.

As an alternative, since size data on each particle have already been determined during sorting, the size data is used to estimate the weight of an identified particle and, as a result, to evaluate the cardinality of each fraction on the basis of the weight of its particles.

The sorting preferably is carried out on a basis of the dimensions of the particles that are visible in the images. Although the dimensions can be corrupted in specific cases by a kernel-type particle being partially covered by other chopped material or by the visible dimensions of the particle not matching up to the actual dimensions due to perspective-induced shortening, this is taken into account, as necessary, by suitably defining limit values for the assignment to the various fractions.

The limit values preferably are defined such that a first size fraction at least largely contains intact kernels, while a second size fraction should largely contain kernel fragments. “At least largely contain” should be interpreted herein to mean “mostly contains” or “contains substantially all,” for example, at least 80% and preferably 90%.

The dimensions of a natural corn kernel are generally substantially smaller in the direction of the axis of its cob than in the radial direction or in the circumferential direction. Therefore, at least one of the two larger dimensions should be visible, regardless of the direction from which an intact corn kernel is captured by the camera.

A kernel-type particle therefore can be expediently assigned to the second fraction if the largest dimension thereof is less than a predefined fraction of a largest dimension of an intact kernel.

Furthermore, regardless of the perspective from which an intact kernel is captured, the intact kernel should not have a dimension in any direction that is smaller than the axial extension of the kernel. A kernel-type particle can be assigned to the second fraction with certainty therefore if the smallest dimension thereof is less than a predefined fraction of a smallest dimension of the intact kernel.

In a further processing step, the determined cardinalities of the fractions are compared to a set distribution. The result of such a comparison is displayed to a driver of the forage harvester in order to prompt the driver to correct the setting of the after-treatment device, i.e., the width of the cracker gap, the speeds, or the speed differential of its rollers, if necessary.

On the basis of the comparison, it also is possible to derive a recommended setting for the after-treatment device and for this recommendation to be displayed. In order to relieve the driver of the forage harvester, it is expedient for the after-treatment device, in particular the width of the cracker gap and/or the speed of the rollers, to be automatically controlled on the basis of the comparison.

The invention also provides a computer program product having program code means, which enable a computer to execute a method as described above.

The invention further provides a forage harvester comprising an after-treatment device for cracking kernels contained in the chopped material, a camera for capturing images of the chopped material and an evaluation unit. The evaluation unit is configured to identify images of kernel-type particles in the images, to sort the kernel-type particles into at least two size fractions on the basis of the images and to determine the cardinality of the size fractions.

The evaluation unit also compares the determined cardinalities to a default, whether the objective is to display the result or a recommended setting based thereon or to control the after-treatment device itself on the basis of the result of the comparison. A user interface provides a driver/operator with an option of making a selection between at least two defaults for the comparison. These defaults can be optimized, in particular, for a use of the chopped material in biogas production or for a use as animal feed. All that the driver then needs to know is the intended use of the chopped material in order to be able to implement an appropriate setting at the user interface, i.e., a grain size of the chopped material that is appropriate for the particular intended use that is selected is then automatically implemented by the evaluation unit.

Further features and advantages of the invention will become apparent from the description of embodiments that follows, with reference to the attached figures, wherein

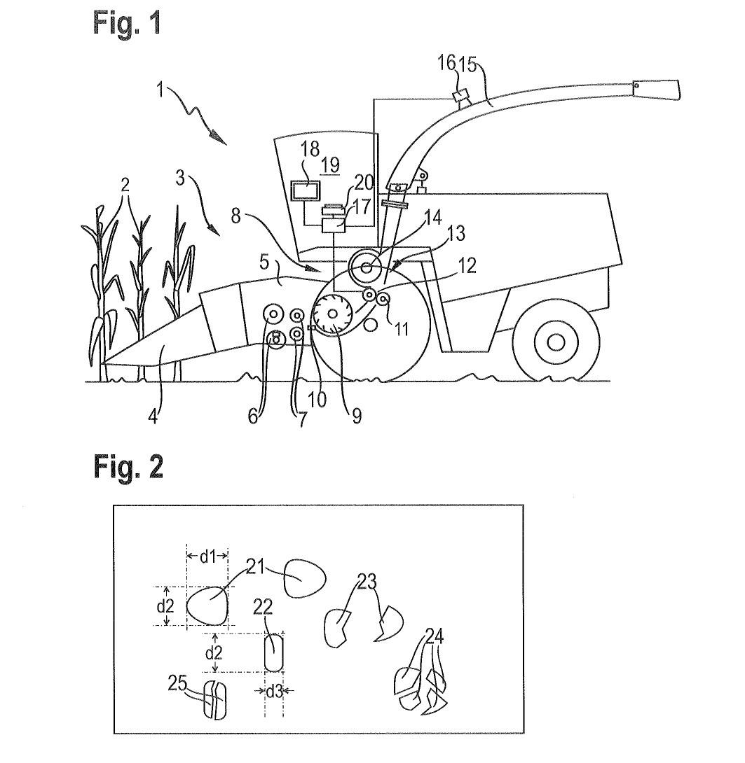

FIG. 1 shows a schematic side view of a forage harvester according to the invention;

FIG. 2 shows a schematic representation of an image of the chopped material captured by a camera of the forage harvester from FIG. 1; and

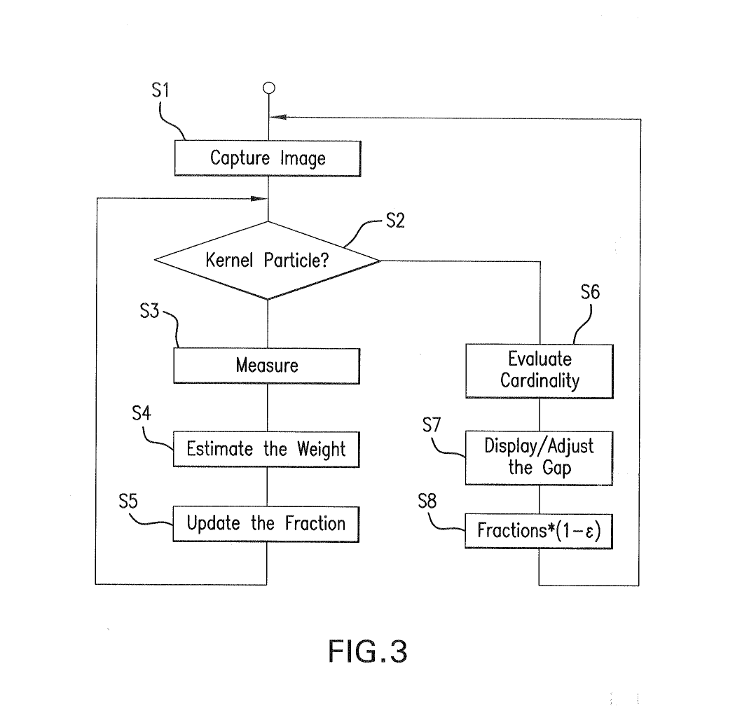

FIG. 3 shows a flow chart of a working procedure of an evaluation unit of the forage harvester.

### DETAILED DESCRIPTION OF THE PREFERRED EMBODIMENTS

The following is a detailed description of example embodiments of the invention depicted in the accompanying drawing. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

FIG. 1 shows a forage harvester 1 according to the invention during harvesting of a crop of corn plants 2 on a field. It should be understood, however, that while corn plants 2 are depicted on the field in FIG. 1, the invention is not limited to a particular crop type. A pick-up device 3 of the forage harvester comprises, in a manner known per se, a front attachment 4 (which can be swapped out according to the plant material to be harvested) and a feeder 5 having a plurality of roller pairs 6, 7. The roller pairs receive the crop from the front attachment 4 in order to feed the crop to a processing unit 8. The processing unit 8 comprises a rotationally driven cutting cylinder 9, a fixed cutting edge 10, over which the plant material is pushed by the adjacent roller pair 7 of the feeder 5 in order to be chopped via the interaction of the cutting edge 10 with the cutting cylinder 9, an after-treatment device 13 and a post-accelerator 14.

The after-treatment device 13 also is referred to as a corn cracker and has a pair of conditioning or cracker rollers 11, which delimit a gap 12 having an adjustable width. The gap 12 also may be referred to in the following as a cracker gap. The conditioning or cracker rollers 11 rotate at different speeds in order to chop corn kernels contained in the material stream passing through the gap 12. The post-accelerator 14 provides the material that has been chopped and that has been conditioned in the after-treatment device 13 with the speed required to pass through a discharge spout 15 and be transferred to a (non-illustrated) accompanying vehicle.

A camera 16 is mounted on the discharge spout 15 in order to capture images of the chopped material conveyed through the discharge spout 15 and deliver these images to an evaluation unit 17. The evaluation unit 17 is connected to a display monitor 18 in a driver's cab 19 of the forage harvester 1 in order to output evaluation results thereon. Furthermore, the evaluation unit 17 controls an actuator for adjusting the width of the cracker gap 12 and/or the speed differential and/or the speed level of the rollers 11. The evaluation unit 17 can be subdivided into an image processing part, which is located directly on the camera 16 in order to minimize the distance across which the large amounts of data delivered by the camera 16 must be transferred, and a control part, which can be mounted, e.g., close to the display monitor 18 in the driver's cab 19.

FIG. 2 shows a schematic view of an image delivered by the camera 16. Stalk and leaf components of the chopped material are not shown in FIG. 2, since these do not play a role in the method according to the invention and are not identified individually by the evaluation unit 17. Kernel-type particles, i.e., whole kernels 21, 22 or kernel fragments 23, 24, 25, can be differentiated from stalk and leave portions in a first step of the image processing by the evaluation unit 17 on the basis of the color thereof and on the basis of the outlines thereof (which usually have sharp edges). The space occupied by the image of a kernel 21, 22 or kernel fragment 23, 24, 25 in the image delivered by the camera depends on the angle at which the kernel or kernel fragment is presented to the camera 16. The kernels 21 are captured by the camera 16 from a direction that approximately corresponds to the longitudinal axis of the cob in which these kernels have grown. Therefore, the kernels 21 are presented to the camera 16 with the two greatest dimensions thereof, a dimension d1 measured in the radial direction of the cob, and a dimension d2 measured in the circumferential direction of the cob. Since a split kernel cannot have dimensions in two mutually orthogonal directions that are as great as those measured for the kernels 21, it can be determined with certainty that the kernels 21 are intact.

The viewing direction of the camera 16 onto the kernel 22 corresponds to the radial direction of the cob in which the kernel 22 was previously located, and therefore the dimension d3 of the kernel 22 in the axial direction of the cob is visible (which is substantially smaller than d1 and d2). The kernel 22 cannot be reliably differentiated from kernel fragments 23, which result from the kernel breaking open in the radial direction, merely on the basis of the dimensions of this kernel that are visible in the image captured by the camera 16. Only when the fragments 23 themselves have been fragmented once more into fragments 24 are the dimensions thereof in two directions substantially smaller than d1 or d2, thereby rendering them unambiguously recognizable as fragments.

The fragments 25 illustrate the very frequent case in which a kernel is torn apart in the axial direction by the shear forces of the conditioning rollers 12 rotating at different speeds. The greatest dimension of the two fragments 25 is d1 or d2, respectively, in this case, but the dimension orthogonal thereto is substantially smaller than d3, and therefore the fragments 25 can be unambiguously detected as such.

FIG. 3 illustrates a working procedure of the evaluation unit 17 on the basis of a flow chart. The procedure starts with an image being captured by the camera (S1). The entire surface of the image is searched for the presence of kernel particles. If a kernel particle is found in step S2, the visible dimensions thereof are determined in step S3. The kernel particle that is found is assigned to a fraction on the basis of the dimensions detected. In the simplest case, this takes place by comparing the largest dimension of the kernel particle found in the image with a limit value, e.g., d3 or a value between d1 and d3, and, if the limit value is exceeded, the kernel particle is assigned to a coarse-grain fraction and if not, the kernel particle is assigned to a fine-grain fraction and a particle counter value of the corresponding fraction is incremented. It is also conceivable to estimate (S4) the weight of the kernel particle on the basis of the dimensions that are determined and, in step S5, to update a value that is representative of the cardinality of the relevant fraction, in order to increment this estimated weight.

Another possibility is to first estimate the weight of the kernel particle on the basis of the measurements and, on the basis of a comparison of this estimated value with a limit value, to assign the particle to the coarse-fine or the fine-grain fraction.

An estimate of the weight assigns to a kernel particle a third dimension in the viewing direction of the camera depending on the two measured dimensions of this kernel particle and accounts for the statistical dependence thereof on the two other dimensions in the calculation of the weight. According to a simplified embodiment, the third dimension is assumed to be identical for all kernel particles; the estimate of the total weight of a particle fraction then boils down to adding up the surface extensions of the images of all kernel particles of a fraction.

A limit value also can be defined as the upper limit of the fine-grain fraction, which is lower than the lower limit of the coarse-grain fraction. It can therefore be ensured that kernel-type particles that, due to the size thereof, cannot, with certainty, be identified as an intact kernel or as a kernel fragment, are not assigned to the fine-grain fraction or to the coarse-grain fraction. Such particles also can be distributed to one or more fractions having an intermediary grain size.

Steps S3 to S5 are repeated until all the kernel particles that can be identified in the image have been evaluated, and then the procedure branches off to step S6, in order to evaluate the cardinality of the fractions that was obtained.

In the simplest case, such an evaluation can take place by outputting the values graphically or numerically on the display monitor 18 and providing the driver of the forage harvester 1 the opportunity to determine whether to adjust the cracker gap or not, in light of the displayed values. In order to simplify this task for the driver, the limit value or the set of limit values, on the basis of which the assignment of the kernel particles to the fractions was carried out, is selected such that fine-grain and coarse-grain fractions have the same cardinality when the cracker gap 12 is set correctly. On the basis of a size comparison of histogram bars, which are shown on the display monitor 18 and correspond to the cardinality of the fractions, the driver can therefore quickly and easily check to determine whether the cracker gap setting is correct or requires adjustment.

At a user interface 20 found in the driver's cab 19 (FIG. 1), the driver has an opportunity to indicate, at the beginning of a harvesting operation, whether the plants 2 to be harvested are intended for biogas production or for animal feed. Based thereon, the evaluation unit 17 selects, in accordance therewith, the suitable limit values or limit value sets for the determination from several stored limit values or limit value sets. The limit value used for the assignment to the fractions can be independent of the intended use of the crop and, instead, the cardinality relationship of the fractions to aim for is predefined depending on the intended use.

Instead of merely displaying the evaluation result for driver adjustment, the evaluation unit 17 is can intervene in the operation of the cracker gap and reduce the gap width thereof, in step S7, if the cardinality of the coarse-grain fraction relative to the fine-grain fraction is higher than desired or, conversely, to increase the gap width if the fine-grain fraction is too high. In this case, the control by the driver for the chopping process can be limited to specifying the intended use of the chopped material at the beginning. A control of the cracker gap 12, by which the kernels are chopped with the required extent of fineness but no fuel is wasted for unnecessarily fine chopping, is carried out fully automatically pursuant to the evaluation.

In step S8, the cardinality values of the fractions are multiplied by a forgetting factor (1-0 of slightly less than 1. Since this takes place regularly, i.e., approximately once per image in this case, divergence of the cardinality values is prevented and the influence of images captured a relatively long time ago is continuously reduced over the course of time.

### REFERENCE SIGNS

1 forage harvester
2 corn plant
3 pick-up device
4 front harvesting attachment
5 feeder
6 roller pair
7 roller pair
8 processing unit
9 cutting cylinder
10 cutting edge
11 cracker roller
12 cracker gap
13 after-treatment device
14 post-accelerator
15 discharge spout
16 camera
17 evaluation unit
18 display monitor
19 driver's cab
20 user interface
21 kernel
22 kernel
23 kernel fragment
24 kernel fragment
25 kernel fragment

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A method for operating a forage harvester, comprising steps of:
capturing images of chopped material produced in the forage harvester using a camera;
identifying images of kernel-type particles in the images;
sorting the images of the kernel-type particles into at least two size fractions; and
determining the cardinality of the size fractions.

2. The method according to claim 1, wherein the step of determining includes evaluating the cardinality of each of the size fractions based on a number of particles thereof.

3. The method according to claim 1, wherein the step of determining includes evaluating the cardinality of each of the size fractions based a weight of the particles thereof.

4. The method according to claim 1, wherein the step of sorting includes evaluating dimensions (d1-d3) of the kernel-type particles that are visible in the images.

5. The method according to claim 1, wherein a first of the size fractions is defined as containing mostly intact kernels and wherein a second of the size fractions is defined as containing mostly fragmented kernels.

6. The method according to claim 5, in which a kernel-type particle is assigned to the second fraction when a largest dimension thereof falls below a predefined fraction of a largest dimension (d1) of an intact kernel.

7. The method according to claim 5, in which a kernel-type particle is assigned to the second fraction when a smallest dimension thereof falls below a predefined fraction of a smallest dimension (d3) of an intact kernel.

8. The method according to claim 1, further comprising a step of comparing the determined cardinalities with a set distribution.

9. The method according to claim 8, wherein the step of comparing further includes deriving and displaying a recommended setting for an after-treatment device is derived and displayed.

10. The method according to claim 8, wherein the step of comparing further includes controlling the after-treatment device base (13) based on the comparing.

11. The method according claim 8, wherein a set width of a cracker gap of the after-treatment device, a speed of at least one roller delimiting the cracker gap or a speed differential between two rollers delimiting the cracker gap is derived by the comparing.

12. A computer program product having program code means, which enables a computer to execute a method for operating a forage harvester, the method comprising steps of:
capturing images of chopped material produced in the forage harvester using a camera;
identifying images of kernel-type particles in the images;
sorting the images of the kernel-type particles into at least two size fractions; and
determining the cardinality of the size fractions.

13. A forage harvester comprising:
an after-treatment device for cracking kernels contained in the chopped material;
a camera for capturing images of the chopped material; and
an evaluation unit configured to identify images of kernel-type particles in the images, to sort the kernel-type particles into at least two size fractions on a basis of the images and to determine a cardinality of the size fractions.

14. The forage harvester according to claim 13, wherein the evaluation unit compares the determined cardinalities of the size fractions with a default.

15. The forage harvester according to claim 14, further comprising a user interface for selecting between at least two defaults.
